(19) United States
(12) Patent Application Publication
(10) Pub. No.: US 2012/0041784 A1
(43) Pub. Date: Feb. 16, 2012

(54) Computerized Surveillance of Medical Treatment

(75) Inventors: Faisal Farooq, Norristown, PA (US); Romer E. Rosales, Downingtown, PA (US); Shipeng Yu, Exton, PA (US); Balaji Krishnapuram, King of Prussia, PA (US); Bharat R. Rao, Berwyn, PA (US)

(73) Assignee: SIEMENS MEDICAL SOLUTIONS USA, INC., Malvern, PA (US)

(21) Appl. No.: 13/228,661

(22) Filed: Sep. 9, 2011

Related U.S. Application Data
(63) Continuation-in-part of application No. 12/190,675, filed on Aug. 13, 2008.
(60) Provisional application No. 61/381,083, filed on Sep. 9, 2010.

(51) Int. Cl. G06Q 50/24

(52) U.S. Cl. 705/3

(57) ABSTRACT

Medical treatment is automatically surveyed. Drugs or other treatments may be monitored post-market. This surveillance may be accomplished in two ways: (1) Identify patients that potentially match templates consistent with possible adverse reactions, possibly including adverse reactions not associated with the treatment. Potentially, if the match is good enough, a single patient may be sufficient to raise an alert. Alternately, multiple patients partially matching a template may cause an alert. (2) Identify patient clusters with unusual patterns. Multiple patients associated with greater rates of adverse events or event severity not expected with the treatment are identified. The data for surveillance is acquired from multiple sources, so may be more comprehensive for early recognition of adverse effects. Data gathering and surveillance are computerized, so early, cost effective recognition may be more likely.

### CROSS REFERENCE TO RELATED APPLICATIONS

This application is a continuation-in-part of U.S. application Ser. No. 12/190,675, filed Aug. 13, 2008, which is a continuation of U.S. Pat. No. 7,457,731, filed Dec. 13, 2002, and this application claims the benefit of U.S. Provisional Application Ser. No. 61/381,083, filed on Sep. 9, 2011, which is incorporated by reference herein in its entirety.

### FIELD

The present embodiments relate to medical information processing systems, and, more particularly to computerized surveillance of treatment or pharmacological vigilance.

### BACKGROUND

Clinical trials performed before drug or other treatment approval may not be sufficient for a full pharmacological evaluation. The mix of patients and evaluations in clinical trials may not be sufficient to consider all possible side effects or other adverse reactions. Some categories or classes of patients may be underrepresented or not represented at all in a clinical study. The relative numbers of patients receiving the treatment is small for a clinical study as compared to the post-market use. The post-market use of the treatment may indicate additional side effects or other adverse reactions.

Without the analysis provided as part of a clinical study, post-market information about side effects or other adverse reactions may go undetected. Insurance or government agency information may be used to automatically determine outcome for a treatment. This may be used for post-market examination of the treatment, but may not adequately identify adverse effects. Manual review is expensive or time consuming. Where detected, the detection may be slower to occur.

### SUMMARY

The present embodiments provide techniques for automated surveillance of medical treatment. Drugs or other treatments may be monitored post-market, after completion of clinical trails, or Food and Drug Administration (FDA) approval of labeling. This surveillance may be accomplished in two ways: (1) Identify patients that potentially match templates consistent with possible adverse reactions, possibly including adverse reactions not associated with the treatment. Potentially, if the match is good enough, a single patient may be sufficient to raise an alert. Alternately, multiple patients partially matching a template may cause an alert. (2) Identify patient clusters with unusual patterns. Multiple patients associated with greater rates of adverse events or event severity not expected with the treatment are identified. The data for surveillance is acquired from multiple sources, so may be more comprehensive for early recognition of adverse effects. Data gathering and surveillance are computerized, so early, cost effective recognition may be more likely.

In a first aspect, a method is provided for automated surveillance of medical treatment. Patient records are obtained for a plurality of patients taking a medication, the medication being a post-market. A processor monitors the patient records for the patients taking the medication. The processor identifies a possible adverse reaction of at least one of the patients to the medication in response to the monitoring. The possible adverse reaction is reported.

In a second aspect, a non-transitory program storage device is readable by a machine. The program storage device tangibly embodies a program of instructions executable on the machine for automated surveillance of medical treatment. The instructions include obtaining patient records for a plurality of patients having previously received treatment of a first type, the plurality of patients associated with different physicians and different medical facilities, extracting a pattern from similarities of the patient records for the patients having received treatment of the first type, the pattern being of an anomalous symptom different from a reaction profile of the previously received treatment, and generating an alert in response to the extracting.

In a third aspect, a system is provided for automated surveillance of medical treatment. A memory is configured to store data for a plurality of patients. A processor is configured to select patients having received or receiving a prescribed drug, to correlate the data with knowledge of a reaction profile to the prescribed drug, to identify a reaction by a plurality of the patients based on the reaction profile, and to output the identification of the reaction and an indication of the prescribed drug.

These and other aspects, features and advantages of the present embodiments will become apparent from the following detailed description of preferred embodiments, which is to be read in connection with the accompanying drawings.

### BRIEF DESCRIPTION OF THE DRAWINGS

FIG. 1 is a block diagram of one embodiment of a computer processing system for automated surveillance of medical treatment;

FIG. 2 shows an exemplary data mining framework for mining structured clinical information;

FIG. 3 shows an exemplary system for automated surveillance of medical treatment, according to one embodiment; and

FIG. 4 shows a flow chart of one embodiment of a method for automated surveillance of medical treatment.

### DESCRIPTION OF THE EMBODIMENTS

Automatic post-market surveillance of drugs, medications, or other treatments (e.g., radiation, ultrasound, ablation, cauterization, grafting, or implantation) may raise an alert in anomalous cases. Some side effects are identified as part of clinical trials or approval of a treatment. The incidence of these side effects may be monitored to update the expected rate and severity associated with the side effects. Unexpected or anomalous side effects may also or alternatively be identified by monitoring. Classes of patients for which the severity or anomalous side effect may be identified. Outlier features for a plurality of patients receiving treatment are identified.

The monitoring relies on data from electronic medical records (EMRs), radiology information systems (RIS), pharmacological records, or other medical data storage. For example, the stored data includes diagnosis codes, lab results, pharmacy information, doctor notes, images, and/or genotypic information. According to various exemplary embodiments, patient records are obtained from these and/or other structured and unstructured data sources.

The patient records are then analyzed by correlating selected patient data contained in the patient records with adverse reaction profiles for each of a plurality of adverse reactions or with itself for identifying causal relationships between variables. A probability of an adverse reaction is estimated at least in part based on one or more of these correlations. If any of the estimated probabilities exceeds a threshold value, an adverse reaction alert is output. The adverse reaction profiles may be defined by adverse reaction progression models, which may be stored in a knowledge base. For example, an allergic reaction may include a rash and swelling in the first 2-3 days and fever after the fourth day. As another example, an increased chance of heart attack may result in some patients in response to taking a medication. The symptoms and progression associated with heart attacks may be included in the knowledge base for correlation with the data for patients being treated.

By performing the vigilance and surveillance of treatments across various patients, patterns of adverse reaction may be better identified. The patient records for patients associated with different medical facilities, different physicians, or both are monitored. Through service or other agreements with the medical facilities or physicians, patient data across a larger representative sample of patients as compared to a clinical trial is available. The facilities, physicians or other medical institutions are within a same region or country, or may be spread across different regions (e.g., cities or states) and/or countries. Correlation is performed over a larger collection of patients than is typically available to a given physician or department.

To facilitate a clear understanding of the present embodiments, illustrative examples are provided herein which describe certain aspects. However, it is to be appreciated that these illustrations are not meant to limit the scope, and are provided herein to illustrate certain concepts associated with the embodiments.

It is also to be understood that the present embodiments may be implemented in various forms of hardware, software, firmware, special purpose processors, or a combination thereof. The present embodiments may be implemented in software as a program tangibly embodied on a non-transitory program storage device. The program may be uploaded to, and executed by, a machine comprising any suitable architecture. Preferably, the machine is implemented on or as a computer having hardware such as one or more central processing units (CPU) (processors), a random access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform, such as an additional data storage device and a printing device.

It is to be understood that, because some of the constituent system components and method steps depicted in the accompanying figures may be implemented in software, the actual connections between the system components (or the process steps) may differ depending upon the manner in which the embodiment is programmed.

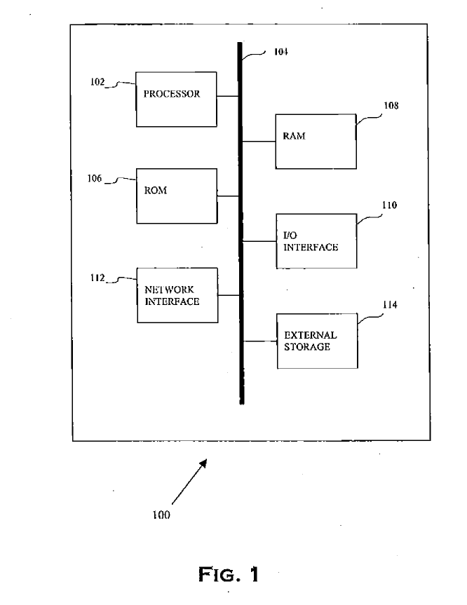

FIG. 1 is a block diagram of a computer processing system 100 for automated surveillance of medical treatment. The system 100 includes at least one processor (hereinafter processor) 102 operatively coupled to other components via a system bus 104. A read-only memory (ROM) 106, a random access memory (RAM) 108, an I/O interface 110, a network interface 112, and external storage 114 are operatively coupled to the system bus 104. Various peripheral devices such as, for example, a display device, a disk storage device (e.g., a magnetic or optical disk storage device), a keyboard, and a mouse, may be operatively coupled to the system bus 104 by the I/O interface 110 or the network interface 112.

The computer system 100 may be a standalone system or be linked to a network via the network interface 112. The network interface 112 may be a hard-wired interface. However, in various exemplary embodiments, the network interface 112 may include any device suitable to transmit information to and from another device, such as a universal asynchronous receiver/transmitter (UART), a parallel digital interface, a software interface or any combination of known or later developed software and hardware. The network interface may be linked to various types of networks, including a local area network (LAN), a wide area network (WAN), an intranet, a virtual private network (VPN), and/or the Internet.

The external storage 114 may be implemented using a database management system (DBMS) managed by the processor 102 or other processor and residing on a memory, such as a hard disk. The external storage 114 may be implemented on one or more additional computer systems. For example, the external storage 114 may include a data warehouse system residing on a separate computer system. Those skilled in the art will appreciate that other alternative computing environments may be used without departing from the spirit and scope of the present invention.

In one embodiment, the processor 102 is configured to implement instructions in the external storage 114, RAM 108, ROM 106, cache, internal memory, or other non-transitory storage medium. The instructions are for automated surveillance of medical treatment.

The memory (e.g., external storage 114, RAM 108, ROM 106, cache, internal memory, or other non-transitory storage medium) may alternatively or additionally store data for a plurality of patients. The data is for patients from different medical facilities, different physicians, or different medical facilities and different physicians. A collection of memories may store the patient data, such as electronic medical record systems of different medical facilities. Alternatively, the memory stores patient data compiled or acquired from the electronic medical record systems of others.

The patient data is data as kept in patient medical records or other electronic storage systems. Alternatively, the patient data is an extracted sub-set of data, such as data to be used for surveillance. In yet other embodiments, the patient data is structured data mined from patient medical records (i.e., output by data mining).

The data sources used to determine the adverse reactions may include the entire patient record. This would entail the use of both structured data sources and unstructured data sources. The structured data sources may include various data bases, e.g., laboratory database, prescription database, test result database. The unstructured data sources may include information in text format (such as treatment notes, admission slips, and reports), image information, and waveform information. This would allow a patient to be tracked not just in the emergency room, but also through the intensive care unit, radiology, other departments, and across different medical facilities and/or physicians.

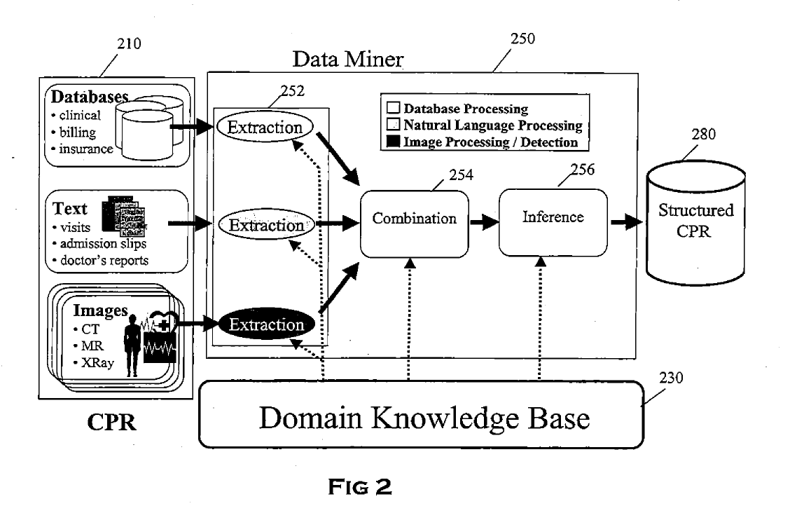

FIG. 2 illustrates an exemplary data mining framework as disclosed in “Patient Data Mining,” by Rao et al., U.S. Patent Application Publication No. 2003/0120458, filed on Nov. 2, 2002, which is incorporated by reference herein in its entirety. As illustrated in FIG. 2, an exemplary data mining framework for mining high-quality structured clinical information includes a data miner 250 that mines information from a computerized patient record (CPR) 210 using domain-specific knowledge contained in a knowledge base (230). The data miner 250 includes components for extracting information from the CPR 252, combining all available evidence in a principled fashion over time 254, and drawing inferences from this combination process 256. The mined information is stored in a structured CPR 280.

The extraction component 252 deals with gleaning small pieces of information from each data source regarding a patient, which are represented as probabilistic assertions about the patient at a particular time. For example, an admission form with “non-smoker” indication is a piece of evidence for a “smoker” variable and is assigned a probability of indicating that the patient is a smoker (e.g., 5% chance the patient is a smoker when “non-smoker” is indicated in an admission form). The probabilities are based on studies, machine-learning, expert knowledge, or other sources. These probabilistic assertions are called elements. The combination component 254 combines all the elements that refer to the same variable at the same time period to form one unified probabilistic assertion regarding that variable. The inference component 156 deals with the combination of these concepts, at the same point in time and/or at different points in time, to produce a coherent and concise picture of the progression of the patient's state over time.

The present embodiments build on the data mining framework depicted in FIG. 2. It makes use of the mined information stored in the structured CPR 280 to identify patients with adverse reactions in response to a treatment.

Advantageously, the method may be performed at either a health care facility or elsewhere. For example, the correlating step may be performed at a central location and the data sources may be provided using a networked hospital information system. The outputted adverse reaction alert may be sent to a monitoring facility, drug manufacturer, treatment sponsor, accreditation organization, physicians' group, medical facility, or government agency.

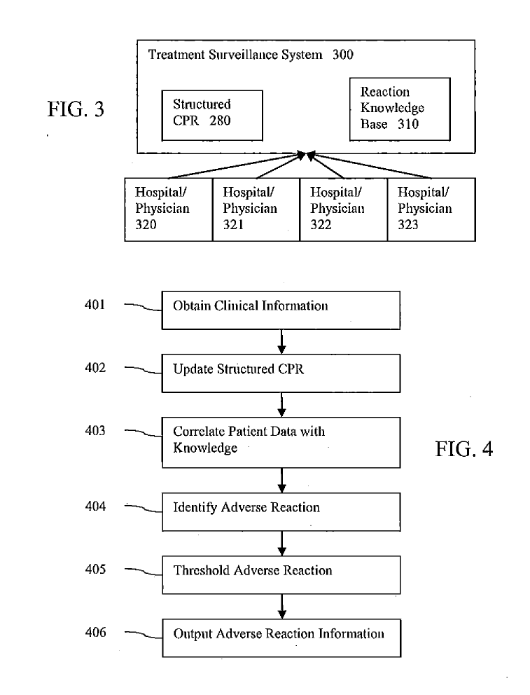

Referring to FIG. 3, an automated adverse reaction detection system 300 is illustrated. The automated adverse reaction detection system 300 is operatively connected to the structured CPR 280 and includes a treatment reaction knowledge base 310. Hospitals 320-323, physicians, other medical facilities, government agencies, drug manufacturers, and/or other organizations may communicate with the automated adverse reaction detection system 300 via a suitable network (not shown). To comply with privacy requirements, patient identification may be stripped off medical data before transmitting to an outside facility.

The data sources used to determine the adverse reaction may include the entire or a portion of the patient record. This may entail the use of both structured data sources and unstructured data sources. The structured data sources may include various data bases, e.g., laboratory database, prescription database, test result database. The unstructured data sources preferably will include information in text format (such as treatment notes, admission slips, and reports), image information, and waveform information.

In operation, the data miner 250 mines patient medical records for patients being treated. The patients are at, seeing, have been discharged, received a prescription from or otherwise associated with the healthcare facilities or physicians, such as the hospitals or physicians 320-323. The data miner 250 then forms probabilistic assertions about various aspects of the patient e.g., a progression of symptoms), and stores this information in the structured CPR 280. For example, a pharmacy database, discharge papers, and/or physicians note may indicate that a patient is taking a particular drug. The list of patients associated with a given treatment may be created by data mining. As another example, from statements found in a medical treatment note, it may be concluded, with some degree of probability, that the patient has a rash, swelling, and fever. In addition, the adverse reaction and/or treatment progression may be determined.

For surveillance, the processor 102 (FIG. 1) is configured to select patients having received or receiving a prescribed drug or other treatment. The list of patients is received as data from a pharmacy (e.g., national chain), from medical entities, and/or by mining. The processor 102 selects the patients by accessing the list. Patients associated with a particular treatment (e.g., a specific drug) or class of treatment (e.g., all drugs of a particular type) are found.

The processor 102 is configured to identify any possible or likely adverse reactions possibly or likely due to the treatment. The automated adverse reaction detection system 300 (FIG. 3) retrieves patient clinical information from the structured CPR 280, and consults treatment or adverse reaction models stored in the knowledge base 310. Adverse reactions or patterns anomalous to the treatment are identified. The patient data is correlated with knowledge of a reaction profile to the prescribed drug or other treatment. For each treatment, one or more templates with various reaction or treatment progression indicia are obtained, and correlated with the elemental information selected from the structured CPR 280. For example, the typical patient for a drug may have a sequence of reduction or cure of symptoms associated with the disease being treated. When the sequence deviates from the expected times, rate, or severity, the anomalous reaction may be identified by correlation. As another example, the adverse reactions associated with the treatment may have a sequence of symptoms. When the patient data matches the sequence or has similarities to the sequence, the adverse reaction may be identified by correlation. In yet another example, symptoms not associated with another adverse reaction indicia or symptoms associated with an adverse reaction sequence not associated with the treatment are identified by correlation. As will be discussed in greater detail with respect with FIG. 4, an adverse reaction may be indicated even when relatively low individual correlation values exist, if there is a cluster of patients each with similar adverse reaction indicia.

Using the correlation, the processor 102 identifies a reaction by a plurality of the patients based on the reaction profile. For example, correlation is used to identify a reaction as an allergic reaction, an anomalous symptom, or the allergic reaction and the anomalous symptom.

A class of the patients with the reaction may be identified. The processor 102 uses the list of patients with an adverse reaction and searches for any other correlations in the patient data. The other correlations may be restricted, such as correlating age, race or other variables. Where sufficient correlation occurs, the class of patients (e.g., males) reacting adversely is identified.

The processor 102 outputs identified patients and/or reactions. For example, an alert is sent. The alert may be a notice, such as sent to a manufacturer or other associated with distributing the treatment. The alert may be sent as an emergency publication, such as being sent to physicians, pharmacies, and/or medical facilities.

The alert includes the adverse reaction. The common occurrences associated with the adverse reaction, such as the reaction profile, may be included. Patients or other patient identifying information are not included, but may be. The class of patients associated with the anomaly or adverse reaction may be indicated in the alert. The treatment, such as the prescribed drug, associated with the adverse reaction is included.

FIG. 4 shows one embodiment of a method for automated surveillance of medical treatment. The method is implemented by the system 100 of FIG. 1 or a different system. The method is performed in the order shown or a different order. Additional, different, or fewer acts may be provided. For example, acts 404 and 405 are combined where thresholding is used to identify the adverse reaction.

In act 401, patient records are obtained. The patient records are obtained for a plurality of patients. Values of variables for patients regardless of whether the patient is associated with a treatment may be obtained. Alternatively, values of variables for patients associated with a treatment are obtained. Insurance, Medicare, healthcare facility, or other group provides a list of patients.

The patients associated with a treatment are identified. One or more variables may be for the treatment (e.g., patient taking drug X), indicating patients to be on the list. A list of patients may be provided and used without consulting a variable of the patient medical records. The patients that have previously received the treatment are selected. Previous receipt of treatment includes patients undergoing the treatment, such as where the treatment involves a sequence over hours, days, or months.

The treatment is of any type. For example, the treatment is a pharmacological treatment. Chemotherapy or other drugs are taken by a patient at a medical facility or at other locations. Other example types of treatment include radiation, ultrasound, implantation, or grafting.

The treatments are post-market or after FDA approval. Pre-clinical and clinical studies are performed and used by the FDA to label the treatment for use. Once labeling is approved, the treatment may be prescribed or used outside of the clinical trial setting.

The patients for whom data is obtained are associated with different medical facilities and/or physicians. Since the treatment is post-market, different medical entities may prescribe or deliver the treatment. By agreement for access to data, using publicly available data, by waiver from patients, or other arrangement, data from different medical entities is available.

Values for variables associated with the treatment are obtained. For example, the knowledge base indicates a plurality of different variables associated with one or more treatment or adverse reaction profiles. The values for these variables are obtained. Alternatively, values for additional or different variables are obtained. Gathering values for many different variables reflecting many different patient states may be used for correlation to identify anomalous symptoms associated with a treatment. A general list of variables representing many different aspects of patient care may be gathered.

The patient data is collected by entry of the data into a structured database. Alternatively, the patient medical record is searched to find values for variables. The values provided are assumed to be accurate.

In an alternative embodiment, data is mined from individual data collections of the patients receiving the treatment. Any data mining may be used. In one embodiment, the data mining probabilistically combines different pieces of evidence to determine the most likely value for a variable rather than assuming any one piece of information is accurate. The data mining obtains the evidence from different sources, both structured and unstructured (text format, image information, and/or waveform information). For example, treatment or doctors notes in text format are included in the mining. The patient medical records are in a machine readable dataset. A processor derives information from the unstructured data source and information from a structured data source. Clinical information is mined from structured and unstructured data sources.

In act 402, a structured data source is updated with the mined or otherwise obtained patient information. The extracted values for variables are collected for use in surveillance. The collection of patient data is stored in one database. Alternatively, multiple databases or even the memories associated with the patient medical records are used to store the structured data. The structured data has defined fields each associated with a given variable. The format of the value for each variable is defined.

In one embodiment, the data mining system described in “Patient Data Mining,” by Rao et al., U.S. Patent Application Publication No. 2003/0120458, filed on Nov. 2, 2002, performs acts 401 and 402. Other data mining systems may be used.

In act 403, a pattern is extracted from similarities of the patient records for the patients having received the same treatment or type of treatment. Different patterns may be extracted, such as causal patterns, treatment progression patterns, and/or adverse reaction patterns. For causal patterns, the values for the variables may be examined to determine a cause of an adverse reaction represented in the data. For example, patients associated with a treatment may have a correlation between liver function and the treatment. For treatment progression patterns, the values for the variables may be examined to determine whether the progression of treatments is as expected. Progression by a group of patients outside the norm may be identified. For adverse reaction patterns, the values for the variables may be examined to determine whether the patient state is associated with expected or unexpected but possible adverse reactions.

Where the pattern for treatment progression, adverse reaction progression, or causal relationship is different from a reaction profile for the treatment, an anomalous symptom may be identified. Different or anomalous symptoms compared to symptoms expected from the treatment are extracted. The symptoms may be different due to severity, different type, or both. The clinical trials may establish different adverse reactions and severity. The patterns are extracted to identify a new adverse reaction or an expected adverse reaction but with a different severity. Patterns are used to find outlier features or variables in the patients receiving treatment.

Any type of symptom may be identified from the pattern. For example, an outbreak of an illness or disease is identified. As another example, an allergic reaction is identified. In another example, a contraindication is identified (e.g., liver degradation occurs with a drug, so patients with liver cirrhosis are contraindicated for that drug). Any symptom outside the reaction profile may be identified from the pattern. The reaction of the patients to the treatment is reflected in a reaction profile. The clinical trials or other studies indicate the expected reaction profile for a given treatment. Symptoms in a pattern or across multiple patients and that occur outside of the reaction profile may be identified.

The patient records of the patients receiving the treatment are monitored. Acts 401, 402, and 403 are performed by a processor. These acts are performed in response to a trigger. Any trigger may be used, such as inclusion of the patient on a treatment list, identification of the patient as associated with treatment (e.g., mining indicates treatment), discharge, admission, entry in a pharmacy database, or request from a patient or physician. In other embodiments, the acts are performed periodically. For example, any patient associated with a medical facility or physician may automatically be included on a list. The treatments for each of the patients are identified. In response, the patient records for that patient are periodically (e.g., daily, weekly, or monthly) examined for a pattern associated with any possible adverse reaction.

The pattern associated with a possible adverse reaction is identified by correlation. The possible adverse reaction is associated with more than one patient receiving the treatment. Correlation of information may indicate the possible adverse reaction associated with treatment.

Selected patient data from the patient records is correlated. The patient data to be correlated is selected based on the pattern. All available data may be selected for correlation to identify variable relationships correlating with patients being treated. The relationship may be due to the treatment, the commonality of the illness or the reason for the treatment. Knowledge of the illness or reason for treatment may be used to remove such correlations.

All or a subset of the available data may be selected for correlation with a reaction profile for the treatment. For example, knowledge of the progression of the patient state and corresponding values of associated variables are included in the reaction profile. The values for these variables are selected and correlated. Where patients deviate (e.g., severity or timing) from the reaction profile, the deviation may be identified by the correlation. Values for variables not part of the reaction profile may be used to identify anomalous symptoms. The variables to use may be limited to a set possibly indicating an adverse reaction, such as including a measure of liver function but not including place of residence.

A subset of variables may be selected for correlation with adverse reaction profiles (e.g., allergic reaction). The patient state progression associated with one or more adverse reactions not specific to the treatment or specific to the treatment is provided as a knowledge base. The variables associated with these progressions are selected. The variables are correlated to identify any correlation between the treatment and the adverse reaction. The severity of expected adverse reactions or the existence of correlation with unexpected adverse reactions is identified.

The profiles or indicia may represent a progression, such as symptoms as a function of time. Alternatively, the profile or indicia may represent a patient state at a given time.

The structured data provided in act 402 is used for correlation. Structured data from unstructured and structured data sources may be correlated with allergic reaction indicia, anomalous symptom indicia, or both allergic reaction indicia and anomalous symptom indicia.

The variables to be used are selected based on the concept to be correlated. The knowledge base provides the different profiles or indicia of the adverse reaction, whether expected or unexpected. The profiles or indicia are selected based on the treatment. Alternatively, all of the profiles or indicia are selected for any treatment and the correlation is performed for each.

The selected values of variables obtained from the structured data source are correlated with the selected profile or indicia. Adverse reaction indicia refer to the clinical features associated with a particular adverse reaction. A probability of adverse reaction may be estimated at least in part based on these correlations.

For example, the adverse reaction for an allergy may include a rash during the first 1-4 days after treatment, followed by swelling. The adverse reaction for liver or kidney function may include one or a progression of lab results with low or high counts.

In act 404, a possible adverse reaction is identified. A processor performs the correlation to identify the possible adverse reaction. Where the correlation is with a profile or indicia for an adverse reaction, the adverse reaction may be identified for a given patient. Identifying the adverse reaction for a plurality of patients may indicate a stronger correlation with the treatment. By monitoring, the processor identifies the possible adverse reaction to the treatment in the population of patients.

In one example, the possible adverse reaction is an allergic reaction. The correlation of the data for patients undergoing treatment with a selected allergic reaction profile may indicate a causal relationship between the allergic reaction and the treatment. In another example, correlation of data for patients without a selected profile or with the profile for the reaction to the treatment may indicate a causal relationship between an anomalous symptom and the treatment. A symptom more severe or different than expected may be identified.

The correlation indicates a probability. The strength of the correlation shows a likelihood of an adverse reaction given the treatment.

In act 405, a threshold is applied to the correlation. A sufficiently strong correlation indicates the risk of adverse reaction to the treatment. An adverse reaction with a correlation higher than the threshold identifies the adverse reaction as relevant to the treatment.

The threshold is set by the user. Any threshold of correlation may be used. The thresholds for different profiles and/or adverse reactions may be different. For example, more severe or risky adverse reactions (e.g., liver damage or increased chance of heart attack) may have a lower threshold for identification. Less severe or risky adverse reactions (e.g., hair loss) may have a higher threshold for identification. The threshold value may be adjusted to reduce false alerts. In situations where the severity or risk associated with an adverse reaction is high, the tolerance for false positives may be somewhat relaxed.

The identification of act 404 and the threshold of act 405 may be set to include correlation of act 403 indicating complete matches or partial matches. Partial matches between the selected patient data and the adverse reaction indicia for a treatment of interest may also trigger an alert. Suspicion might also be raised if not all of the patient symptoms match expected symptoms for a particular adverse reaction. Although each case individually may be assigned a probability below the threshold, the joint probability for a group of patients might exceed the threshold, triggering an alert. In each of these cases, the criteria for determining the pertinent criteria may be obtained from expert knowledge, and the adverse reaction knowledge base can be designed to capture the expertise.

For partial matching, a template or profile for an adverse reaction may be viewed as a combination of a series of token concepts. For instance, early indications for allergy may be defined as concepts A, B, C, D, E where the concepts A, B, C, D, and E, may be fever, rash, vomiting, swelling, and back ache. There may be precise constraints such as, A (high fever) lasting at least 2 days, B (rash) occurring after the second day from treatment, C (vomiting) intermittent in the early days of fever, D (swelling) to follow B, and E (back ache) may occur at any time. The constraints may be precise or simply ordering constraints. An exact match occurs if all of the concepts are met, with the constraints satisfied for instance, a patient matches A, B, C, D, and E, with the temporal constraints as satisfied above. In this case, a single patient may be enough to generate an alert.

A partial match may occur in two ways. First, a patient only matches some of the concepts in the template—for example, a patient matches A, C, and D, but no information is present about B and E. Another way is that a patient may match a specific concept partially—for instance, instead of matching “A” (fever for 2 days) completely, the patient may only have had fever for 1 day. Either way, a score may be generated indicating how well a patient's record matches a particular template (e.g., profile or indicia). Then, an alert may be issued if many patients partially match a disease template. The adverse reaction may match with a probability of 1, i.e., there is a 100% probability that the early indications for the adverse reaction have been met. This does not mean that the patient has the adverse reaction, just that there is sufficient evidence to conclude that an alert needs to be raised. For example, if 4 of the 5 concepts for an adverse reaction are met, a simple way to compute the probability of a partial match is 4/5=80%. However, more sophisticated methods may take into account the significance of each of the concepts and the degree of match of the patient record with each concept in computing the probability of a match. For example, if two patients match an adverse reaction X with probability p1 and p2 (and assume p1≧p2), the joint probability that at least one patient has adverse reaction X is at least p1 (or more likely greater). There are many ways to compute this probability. Under a simple-minded assumption, this could be computed as 1−(1−p1)*(1−p2). More sophisticated methods that take into account geographical proximity or other similarities between patients could be employed to compute the joint probability that at least one of the 2 patients has X. This can easily be extended to N patients.

Further, adverse reaction X above may also have concepts O, P, and Q as late indications of disease. In which case, a single patient partially matching the early stage concepts, but matching one or more of the late stage concepts may generate an alert.

A class of patients having the possible adverse reaction may be identified. The aggregate of the patients being correlated may match the reaction profile or not otherwise result in a correlation exceeding a threshold. However, a class of patients with data correlated may indicate a threshold amount of correlation. A class of the patients having the anomalous symptom or other adverse reaction are identified. For example, the patient data for patients contributing to a higher correlation is selected and the correlation performed for just those patients. Using further correlation, variables common to these patients may be identified. Where those variables fall into a given class or are relevant based on the knowledge base, the group of patients may be placed in a class. For example, racial, demographic, genetic, regional, age, sex, or other classification of patients is stored in the knowledge base. The correlation of patient data with a profile or the data itself is performed separately for each of these classes. Classes associated with a different amount of correlation may be identified, indicating decreased or increased risk of adverse reaction by class. As another example, a correlation with an adverse reaction profile of all the selected patients is performed. The correlation is below the threshold. By identifying the patients, from the selected patients, associated with making the correlation higher, the correlation is performed again. If over the threshold, then the data for this subset of patients is examined to identify any variables in common. These variables are used to classify the group.

Where the specified profile or indicia includes a class of patients having one or more symptoms, the class may be identified. For example, suspicion might be raised if ten patients in a particular geographic area all have the same adverse reaction. So, too might be the case where the specified profile or indicia includes a cluster of patients having one or more symptoms. For example, an alert might be issued if ten patients in a particular geographic area all had kidney failure that match a profile for kidney failure or that are anomalous to the treatment reaction profile.

In the case of clusters, suspicion may be raised if not all of the patient symptoms match expected adverse reaction indicia for a particular treatment, but are viewed to be “anomalous”—i.e., they do not match the previously seen or expected pattern or patterns. For instance, on noticing 50 patients were treated in hospitals in the San Francisco area all with symptoms including (possibly a subset of) moderate fever, swollen glands, and difficulty urinating—this may be an unusual combination although not matching any of the adverse reaction templates that could be worthy of examination by an expert. Although each case individually may be assigned a probability below the threshold, the joint probability for a group of patients might exceed the threshold, triggering an alert.

The entire set of concepts corresponding to all the adverse reactions in the database are examined. So if a large group of patients have concepts A, B, M, N, and Z, even though none of these correspond to any of the templates, this may suffice to generate an alert. Unusual patterns are detected. For instance, patterns of known adverse reactions may be used as filters to reduce false alerts. Additionally, seasonal information may be used to adjust the threshold—for instance, many patients with flu-like symptoms in New York City in of flu season may indicate less likelihood of adverse reaction due to the treatment.

Another feature may be that if a large number of patients have flu-like symptoms, but also have another unusual symptom (not associated with the flu—for instance, hair loss) that may suffice to raise suspicion. Unusualness can be measured against known patterns. Also it can be measured against retrospective records—for instance, if there was no record of this combination of concepts (A, B, Q, R, M) in any patients having a treatment in the last two years that may suffice to raise a flag that the treatment is causing the adverse reaction. The data processing requirements for this approach may be simplified by extracting the entire set of concepts from all past patient records, and using that list to efficiently generate a quick match for unusualness.

In act 406, the possible adverse reaction is reported. An alert is generated in response to extracting the adverse reaction indication from the patient data. The alert is output when the estimated probability exceeds the corresponding threshold.

The alert is output to a physician, medical facility, insurance company, government agency, third party service provider, patients, physicians' group, treatment manufacturer, or other entity. The alert is output as a text message, email, document, report, link, or other format.

The alert includes the treatment and other related information. The adverse reaction exceeding the probability may be included. The probability may be included. Any class or clustering information may be included. Supporting information may be included, such as the relevant patient data.

Because it is important to maintain privacy, patient information associated with an alert does not include data regarding the identity of patients. Patient identification may be stripped off medical data before transmitting to an outside facility. Alternately, all that could be shipped could be the results of findings, as in “patients with unexpected reduction in kidney function as compared to the expected treatment reaction.” Then it would be up to the expert viewing the data to decide how to best proceed: request the entire patient record for the associated patients, contact the attending physicians or request extra tests.

In addition to an adverse reaction alert, a request for information may be output. This request for information may include a request to a physician to verify the existence of specified symptoms or to perform additional tests.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for automated surveillance of medical treatment, the method comprising:
obtaining patient records for a plurality of patients taking a medication, the medication being a post-market;
monitoring, with a processor, the patient records for the patients taking the medication;
identifying, with the processor, a possible adverse reaction of at least one of the patients to the medication in response to the monitoring;
reporting the possible adverse reaction.

2. The method of claim 1 wherein obtaining comprises obtaining the patient records for patients from different medical facilities and different physicians.

3. The method of claim 1 wherein obtaining comprises data mining from individual data collections of the patients taking the medication, the information derived with the processor from an unstructured data source including text format, image information, waveform information or combinations thereof, the patient records being a machine readable structured dataset including the information derived with the processor from the unstructured data source and information from a structured data source.

4. The method of claim 1 wherein identifying comprises estimating a probability of the adverse reaction, and wherein reporting comprises outputting an alert when the estimated probability exceeds a corresponding threshold value.

5. The method of claim 1 wherein obtaining comprises deriving at least in part from treatment notes.

6. The method of claim 1 wherein identifying comprises correlating the patient records with a plurality of allergic reaction profiles and selecting one of the allergic reaction profiles with a threshold correlation, the possible adverse reaction comprising an allergic reaction corresponding to the selected allergic reaction profile.

7. The method of claim 1 wherein identifying the possible adverse reaction comprises correlating the patient records with a reaction profile and identifying an anomalous symptom outside the reaction profile, the possible adverse reaction comprising the anomalous symptom.

8. The method of claim 1 wherein identifying the possible adverse reaction comprises identifying as a function of a plurality of temporal constraints on expected reactions.

9. The method of claim 1 wherein identifying comprises identifying a cluster of patients having the possible adverse reaction.

10. The method of claim 9 wherein identifying comprises identifying a racial, demographic, genetic, age, sex, or combinations thereof in common to the patients of the cluster.

11. The method of claim 1 wherein identifying the possible reaction comprises estimating a joint probability that at least two or more of the patients have the possible adverse reaction.

12. The method of claim 1 wherein monitoring comprises periodically examining the patient records for a pattern associated with the possible adverse reaction.

13. The method of claim 1 wherein monitoring comprises correlating selected patient data from the patient records, the patient records comprising structured datasets, including data from unstructured data sources, with allergic reaction indicia, anomalous symptom indicia, or both allergic reaction indicia and anomalous symptom indicia, and wherein identifying comprises identifying at least in part based on the correlations.

14. A non-transitory program storage device readable by a machine, the program storage device tangibly embodying a program of instructions executable on the machine for automated surveillance of medical treatment, the instructions comprising:
obtaining patient records for a plurality of patients having previously received treatment of a first type, the plurality of patients associated with different physicians and different medical facilities;
extracting a pattern from similarities of the patient records for the patients having received treatment of the first type, the pattern being of an anomalous symptom different from a reaction profile of the previously received treatment; and
generating an alert in response to the extracting.

15. The non-transitory program storage device of claim 14 wherein the first type is pharmacological treatment, wherein extracting comprises identifying a cluster of the patients having the anomalous symptom, the anomalous symptom comprising an outbreak, an allergic reaction, a contraindication, or a symptom outside the reaction profile.

16. The non-transitory program storage device of claim 14 further comprising identifying a class of the patients associated with the anomalous symptom.

17. The non-transitory program storage device of claim 14 wherein obtaining patient records comprises obtaining information derived by data mining from individual data collections of the patients having been treated, the information derived from an unstructured data source, the unstructured data source including text format information, image information, waveform information or combinations thereof, the patient records being a machine readable structured dataset including the information derived with the processor from the unstructured data source and information from a structured data source.

18. A system for automated surveillance of medical treatment, the system comprising:
a memory configured to store data for a plurality of patients; and
a processor configured to select patients having received or receiving a prescribed drug, to correlate the data with knowledge of a reaction profile to the prescribed drug, to identify a reaction by a plurality of the patients based on the reaction profile, and to output the identification of the reaction and an indication of the prescribed drug.

19. The system of claim 18 wherein the data is for patients from different medical facilities, different physicians, or different medical facilities and different physicians, and wherein the processor is configured to identify the reaction as an allergic reaction, an anomalous symptom, or the allergic reaction and the anomalous symptom.

20. The system of claim 18 wherein the processor is configured to identify a class of the patients with the reaction.
